(19) United States
(12) Patent Application Publication
(10) Pub. No.: US 2002/0184356 A1
(43) Pub. Date: Dec. 5, 2002

(54) Dynamic production device representation in a distributed environment

(76) Inventors: Shell S. Simpson, Boise, ID (US); Ward S. Foster, Boise, ID (US); Kris R. Livingston, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/874,427

(22) Filed: Jun. 4, 2001

(51) Int. Cl. G06F 15/16; G06F 15/173

(52) U.S. Cl. 709/223; 709/208

(57) ABSTRACT

Representing prodution devices on a computer network. In one embodiment, the invention involves hosting an interface for one or more production devices. Each interface provides user accessible controls for selecting production options for a document. The interface for a selected production device is provided to a client upon request. The production of the document on the selected production device is then managed using production options selected through the interface

### FIELD OF THE INVENTION

The present invention is directed to a method and system for electronic document production. More particularly, the invention is directed to a method and system for representing production devices in a distributed environment.

### BACKGROUND OF THE INVENTION

In a basic desktop computing environment, a printer or other production device is connected directly to a computer. Production devices include printers; finishers such as binders, sorters, or folders; e-mail clients; facsimile devices; web server; and electronic data storage devices. Production devices, however, are not limited to those listed but may include any device capable of electronically or physically saving, displaying, formatting, or transferring a target document. To produce a document, a user either opens or creates an electronic document using a word processor or other application. The user then issues a production request for a selected production device. A driver specific to the selected production device a printer in this example—generates a user interface allowing the user to select options for formatting the document. These options can include, for example, the number of copies, print resolution, specific paper source and output bins. With the desired production options selected, the driver formats the production request into a specialized series of commands directing the printer to produce the document on one or more sheets of paper. To add a new production device, the user connects the new device and installs the new driver for that device on the computer.

In a more complex environment, the computer and production devices are components of a larger network of electronic devices. While new printers and other production devices can be easily connected to the network, drivers for those devices must be individually installed on each client computer that accesses the new device. As updates for the device drivers become available, the updates must also be installed on each client computer.

With the advent of the Internet, new models of document production are evolving. In one system, a client device, a desktop computer for example, utilizing a web browser rather than a particular device driver, accesses a web server embedded in a production device such as a printer. Representing that device on the network, the embedded web server allows the device to be connected directly to the computer network rather than to another device such as a desktop computer. When accessed by a browser, the embedded web server returns a web page containing controls for formatting and printing a selected document. With the document and desired format options selected, the browser returns the document and the user's formatting instructions to the embedded web server, which, in turn, self-manages production of the document on the device.

In another system, the client device, using a browser, accesses a print service—a web site hosted on a server device. The print service presents the user with a selection of printers from which to choose. The browser returns the user's printer selection along with the location of the components of the document to be printed. For example, the text of the document may be located in one location on the network while the color graphics for a cover page may be located elsewhere. The print service then mediates access to a web server embedded in the selected printer. That web server returns a web page allowing the user to select formatting options for the document. With the options selected, the print service compiles the document's components and delivers them along with the selected formatting options to the web server embedded in the selected printer for production.

As is the case whenever technology expands, many existing production devices, designed to directly connect to and be controlled by another device, do not possess the programming needed to represent themselves on a network. Consequently, what is needed is a method and system for representing these devices in these new models of network document production.

### SUMMARY OF THE INVENTION

The present invention is directed to representing production devices on a computer network. In one embodiment, the invention involves hosting an interface for one or more production devices. Each interface provides user accessible controls for selecting production options for a document. The interface for a selected production device is provided to a client upon request. The production of the document on the selected production device is then managed using production options selected through the interface.

### DESCRIPTION OF THE DRAWINGS

FIG. 1 is a schematic representation of a computer network that includes a client device, a server device, and several production devices.

FIG. 2 is a block diagram of the network of FIG. 1 in which the invented proxy service is embodied in a program running on the server device according to one embodiment of the present invention.

FIG. 3 is a block diagram further illustrating the logical components of the proxy service according to one embodiment of the present invention.

FIG. 4 is a block diagram further illustrating the logical components of the service engine according to one embodiment of the present invention.

FIG. 5 is a block diagram further illustrating the logical components of the production engine according to one embodiment of the present invention.

FIG. 6 is a flow diagram illustrating the dynamic device identification process provided by the proxy service according to one embodiment of the present invention.

FIG. 7 is a flow diagram illustrating the document production process provided by the proxy service according to-one embodiment of the present invention.

FIGS. 8 and 9 are exemplary screen views each illustrating a different interface generated by the proxy service.

### DETAILED DESCRIPTION OF THE INVENTION

GLOSSARY

Program: An organized list of electronic instructions that, when executed, causes a device to behave in a predetermined manner. A program can take many forms. For example, it may be software stored on a computer's disk drive. It may be firmware written onto read-only memory. It may be embodied in hardware as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components.

Client—Server: A model of interaction between programs in a distributed environment in which a program operating on one network device sends a request to a program operating on another network device and waits for a response. The requesting program is referred to as the “client” while the device on which the client operates is referred to as the “client device.” The responding program is referred to as the “server,” while the device on which the server operates is referred to as the “server device.” The server is responsible for delivering requested information back to the client. In any given network there may be multiple clients and multiple servers. A single device may contain programming allowing it to operate both as a client device and as a server device.

User Interface: The junction between a user and a computer program providing commands or menus through which a user communicates with a program. For example, in the client-server model defined above, the server usually generates and delivers to a client a user interface for communicating with a program operating on or controlled by the server device. Where the server is a web server, the user interface is a web page. The web page when displayed by the client device presents a user with controls for selecting options, issuing commands, and entering text. The controls displayed can take many forms. They may include push-buttons, radio buttons, text boxes, scroll bars, or pull-down menus accessible using a keyboard and/or a pointing device such as a mouse connected to a client device. In a non-graphical environment, the controls may include command lines allowing the user to enter textual commands.

INTRODUCTION: In a new model for network document production, a user first identifies a target document. A target document is an electronic document selected for production. A target document may comprise two or more components. For example, the document's text may be stored in one electronic file while the document's graphics are stored in another. Each component may be stored on a different network device.

The user then accesses a production server operating on a self-representing production device selected to produce the target document. A self-representing production device has the ability, without the aid of a second device, to communicate over a network and produce a target document upon request. For example, a production device such as a conventional printer is incapable of self-representation and must be connected to and controlled by a second device such as a desktop computer or a print server. A self-representing device typically contains a production server facilitating network communication and managing document production.

The production server returns a user interface allowing the user to select production options for the desired document. A production device such as a conventional printer usually provides only one service, printing. Other production devices provide multiple services. A single device may be able to provide printing, copying, scanning, and facsimile services. For each service, there may exist a number of production options. For example, when printing a document, options can include duplexing, landscape or portrait orientation, and finishes such as stapling or sorting. The desired document and selected options are returned to the production server, which, in turn, manages the target document's production in accordance with the selected production options.

It is expected that by providing a proxy service, embodiments of the invention will allow production devices not capable of self-representation to be incorporated into this new model.

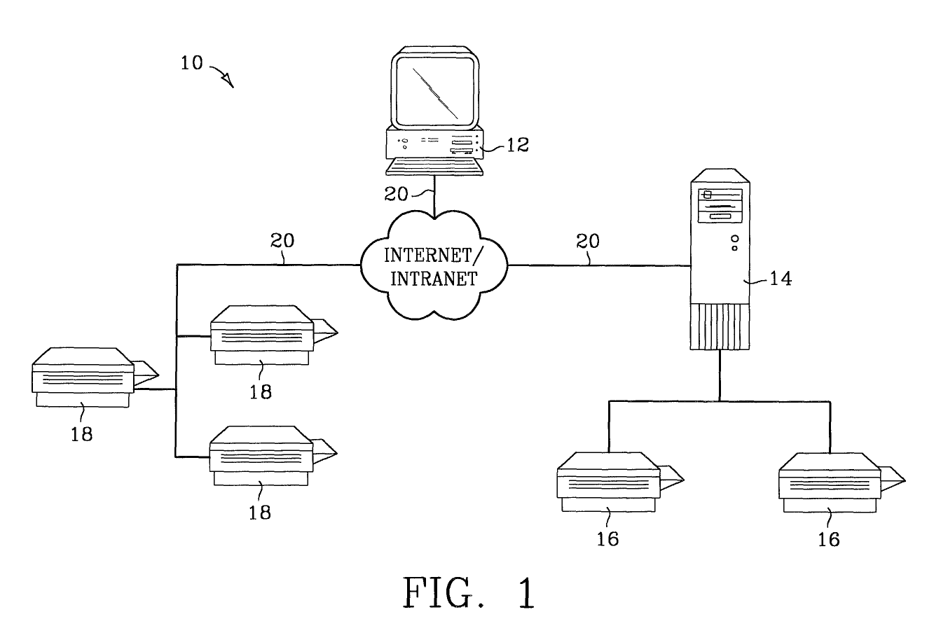

Although the various embodiments of the invention disclosed herein will be described with reference to the computer network 10 shown schematically in FIG. 1, the invention is not limited to use with network 10. The invention may be implemented in or used with any computer system in which it is necessary or desirable to produce documents. The following description and the drawings illustrate only a few exemplary embodiments of the invention. Other embodiments, forms, and details may be made without departing from the spirit and scope of the invention, which is expressed in the claims that follow this description.

Referring to FIG. 1, network 10 represents generally any local or wide area network in which a variety of different electronic devices are linked. Network 10 includes client device 12, typically a personal computer workstation. However, client device 12 can include any device, a personal digital assistant for example, capable of displaying a user interface. Network 10 also includes server device 14, conventional production devices 16, as well as self-representing production devices 18. While represented as printers, production devices 16 and 18 represent any production device present on network 10. While capable of other functions, server device 14 need only manage document production on conventional devices 16.

Communication link 20 interconnects client device 12, server 14, and production devices 18. Communication link 20 represents generally a cable, wireless, or remote connection via a telecommunication link, an infrared link, a radio frequency link, or any other connector or system that provides electronic communication between devices 12, 14, and 18. Communication link 20 may represent an intranet, an Internet, or a combination of both. The path followed by link 20 between devices 12, 14, and 18 in the schematic view of FIG. 1 represents the logical communication path between these devices, not necessarily the physical path between the devices. Devices 12, 14, and 18 can be connected to the network at any point and the appropriate communication path established logically between the devices.

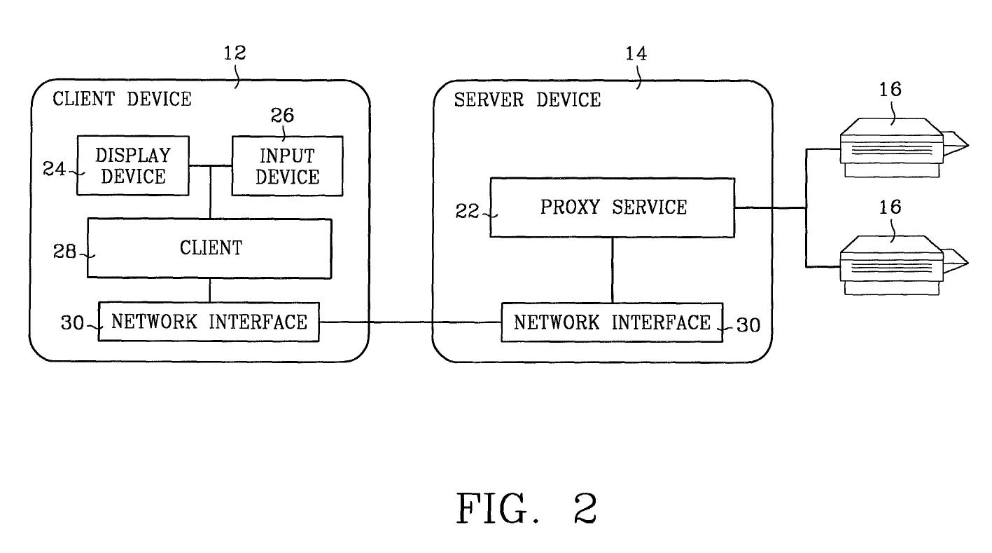

COMPONENTS: The logical components of one embodiment of the invented document production system will now be described with reference to the block diagrams of FIGS. 2-5. In FIG. 2, the invention is embodied in software or other programming, described in more detail below, labeled proxy service 22 operating on server device 14. Proxy service 22 represents generally any programming capable of mediating network communication between client 28 and production devices 16, managing production on those devices. Client device 12 provides a mechanism for presenting a user with an interface for managing document production on production device 16. Client device 12 usually includes a monitor or other suitable display device 24 and a keyboard and/or a pointing device such as a mouse or other suitable input device 26. Client 28 is a program for causing display device 24 to display a desired user interface and for delivering instructions to proxy service 22. Consequently, while client device 12 is illustrated as a device separate from server device 14 and production devices 16 and 18, the function of client device 12 can be incorporated into any network device capable of providing a user interface, which may include devices 14, 16, and/or 18. To facilitate network communication between devices 12, 14, and 16, each includes network interface 30.

While FIG. 2 illustrates proxy service 22 operating on server device 14, it may just as well operate on production devices 18 or client device 12. Moreover, production devices 16 need not be connected directly to server device 14. Production devices 16 may be connected to any device on network 10. Proxy service 22 need only have network access to production devices 16. For example, in a peer-to-peer network, production devices 16 may be identified as shared network devices each connected to a different computer accessible by proxy service 22.

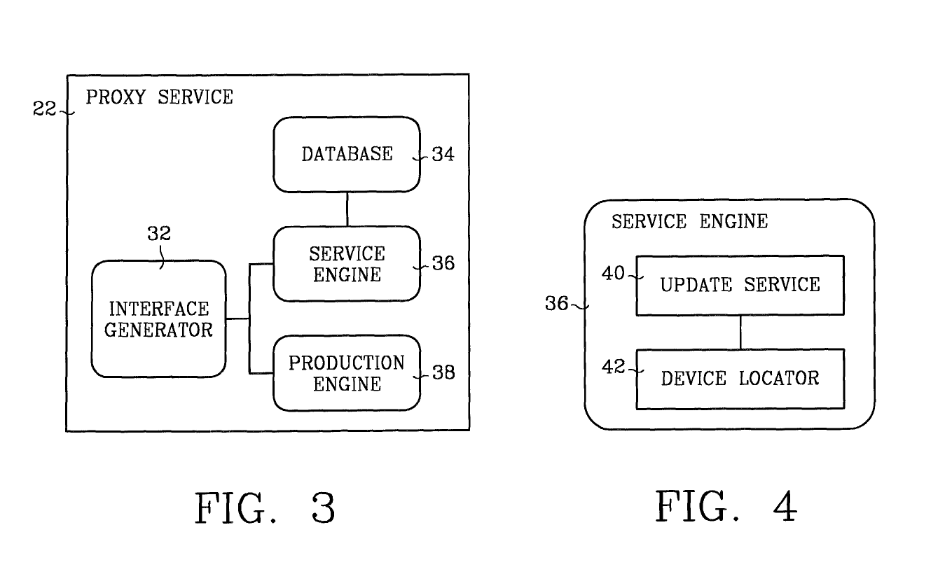

Referring now to FIG. 3, proxy service 22 includes interface generator 32, database 34, service engine 36 and production engine 38. Interface generator 32 represents generally any programming for generating a user interface having user accessible controls for selecting and returning options for producing a document on production devices 16. The interface, usually displayed by client 28, may include controls for selecting a particular document as a target document, or a target document may have been previously identified by the user. Service engine 36 represents generally any programming capable of acquiring production logic for production devices 16, while production engine 38 embodies generally any programming capable of managing production of a target document on production devices 16.

It is envisioned that interface generator 32 will be a web server and that client 28 will be a web browser. A web server is a program that hosts documents, commonly referred to as web pages, for remote retrieval over a network such as the World Wide Web. A web server may also generate those web pages dynamically using data from a variety of sources. Usually, a web server functions as software operating on a network computer, but can be firmware embedded into a network device such as a printer, copier, or even a refrigerator. Web pages can be delivered in a number of formats including, but not limited to, HTML (Hyper-Text Markup Language), ASP (Active Server Pages), and JSP (Java Server Pages). A web browser is a client program for requesting and displaying web pages.

Using HTML (hyper-text mark up language) and/or another internet language, interface generator 32 creates an interface in the form of a web page accessed and displayed by client 28 using a network address assigned to the web page. The network address is usually in the form of an URL (Uniform Resource Locator) or IP (Internet Protocol) address. Beneficially, this allows cross platform communication. For example, client device 12 may be running one operating system such as Microsoft® Windows® while server 14 may be running Unix®.

Database 34 provides electronic storage hosting production logic for production devices 16. Production logic includes information used for managing production of electronic documents on a particular production device. The logic can include a device driver as well as data used to generate a user interface for selecting production options. Such data may include instructions for displaying particular controls; ranges of acceptable values for a particular control setting; a default value for a control setting; and any other information relating to the production of an electronic document.

When creating an interface for a particular production device 16, interface generator 32 accesses the production logic for that device contained in database 34. Services engine 36 is responsible for monitoring network 10 and updating database 34 with production logic for devices connected to the network 10 that are not capable of self-representation. Managing document production, production engine 38 directs one or more selected production devices 16 to produce a target document upon request.

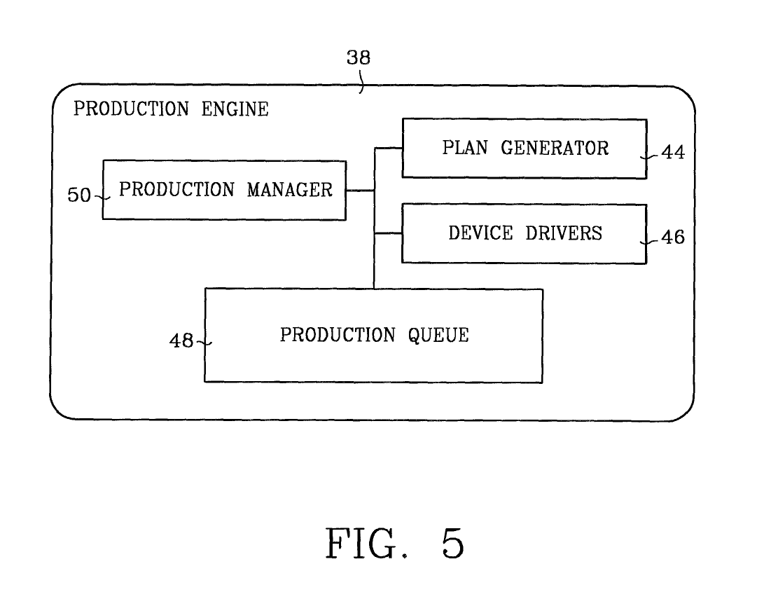

As illustrated in FIG. 4, service engine 36 includes update service 40 and device locator 42. Device locator 42 represents generally any programming capable of detecting and identifying new devices connected to network 10, while update service 40 embodies generally any programming capable of updating proxy service 22 with the production logic for a device identified by device locator 42. Using SNMP (Simple Network Management Protocol) for example, device locator 42 detects when a new device 16 or 18 is connected to network 10 and identifies the new device determining whether a newly connected device has self-representation capabilities. If not, update service 40 determines whether proxy service 22 has the capability to represent the new device. If not, update service 40 accesses an external device information service for that device. A device information service includes any source for retrieving production logic for a particular production device. For example, a device information service may be a web page, a Java program for example, provided by the device's manufacturer or other supplier of device information. Update service, then, accesses the web page, downloads the production logic, and updates database 34. Alternatively, the device information service may be maintained locally or found with the installation files usually provided with each production device. The installation files may be stored in memory contained on the production device or stored on removable media such as a floppy disk or portable compact disk.

For example, when device locator 42 detects the addition of a new device it identifies the device as a conventional laser printer from a particular manufacturer that is not capable of self-representation. Update service 40 queries database 34 for the production logic for the new device. When none is found, update service 40 accesses a web site hosted by the device's manufacturer and acquires the necessary production logic.

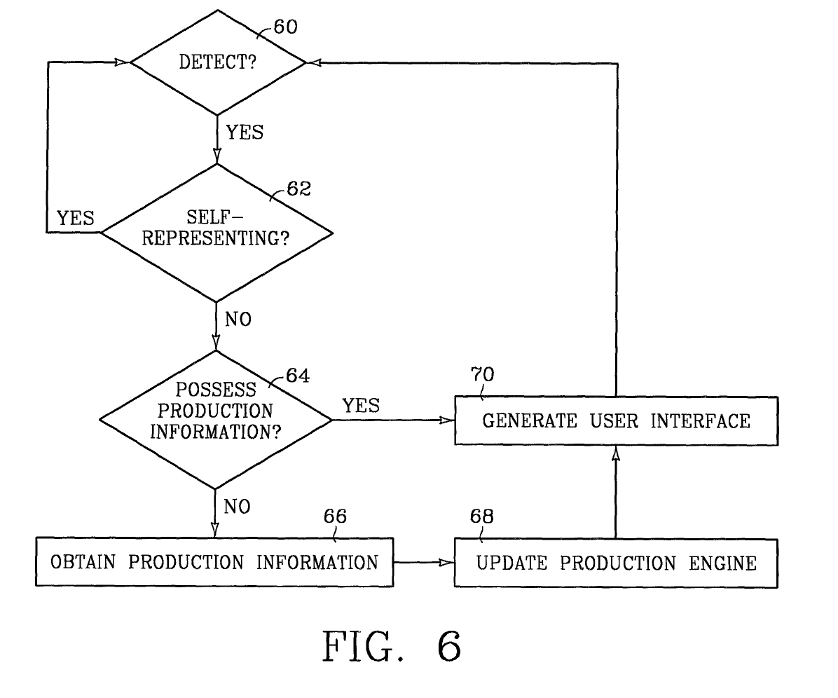

As illustrated in FIG. 5, production engine 38 includes plan generator 44, device drivers 46, queue 48, and production manager 50. Plan generator 44 represents generally any programming capable of associating the target document with the selected production options, thus, forming a production plan. Plan generator 44 may also be responsible for acquiring the target document. Device drivers 46 translate the production plan 44 into a specialized set of commands for the selected production device 16. It is envisioned that update service 64 will also update device drivers 46 with drivers for newly connected production devices.

Production devices such as printers are capable of producing one production plan at a time and occasionally malfunction. Queue 48 is an electronic holding bin allowing production engine 38 to manage production plans directed to a busy or malfunctioning device. Production manager 50 administers the production plans within queue 48. Production manager 50 tracks the status of each production plan and provides interface generator 32 with the information required to generate a user interface for displaying the status of each production plan as well as user accessible controls for directing how production manager 50 manipulates the production plans held within queue 50.

The block diagrams of FIGS. 1-5 show the architecture, functionality, and operation of one implementation of proxy service 22. If embodied in software, each block may represent a module, segment, or portion of code that comprises one or more executable instructions to implement the specified logical function(s). If embodied in hardware, each block may represent a circuit or a number of interconnected circuits to implement the specified logical function(s).

Also, proxy service 22 can be embodied in any computer-readable medium for use by or in connection with an instruction execution system such as a computer/processor based system or other system that can fetch or obtain the logic from the computer-readable medium and execute the instructions contained therein. A “computer-readable medium” can be any medium that can contain, store, or maintain proxy service 22 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as floppy diskettes or hard drives, a random access memory (RAM), a read-only memory (ROM), an erasable programmable read-only memory, or a portable compact disc.

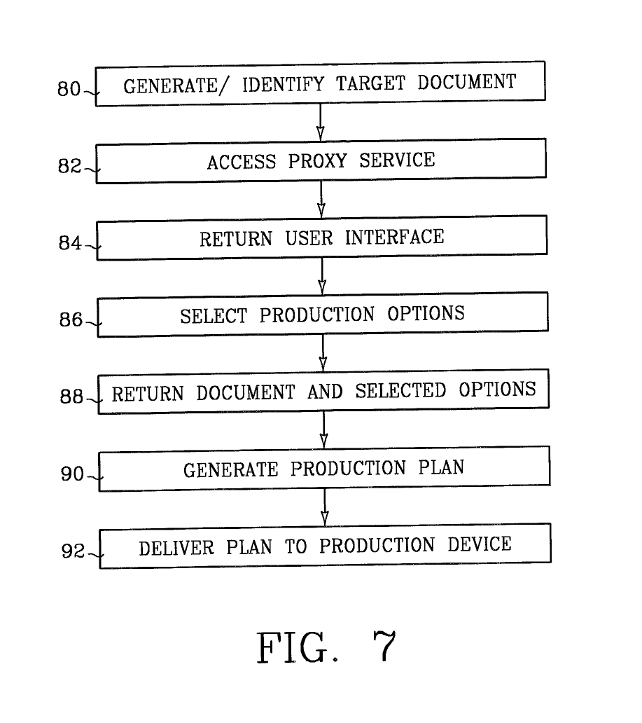

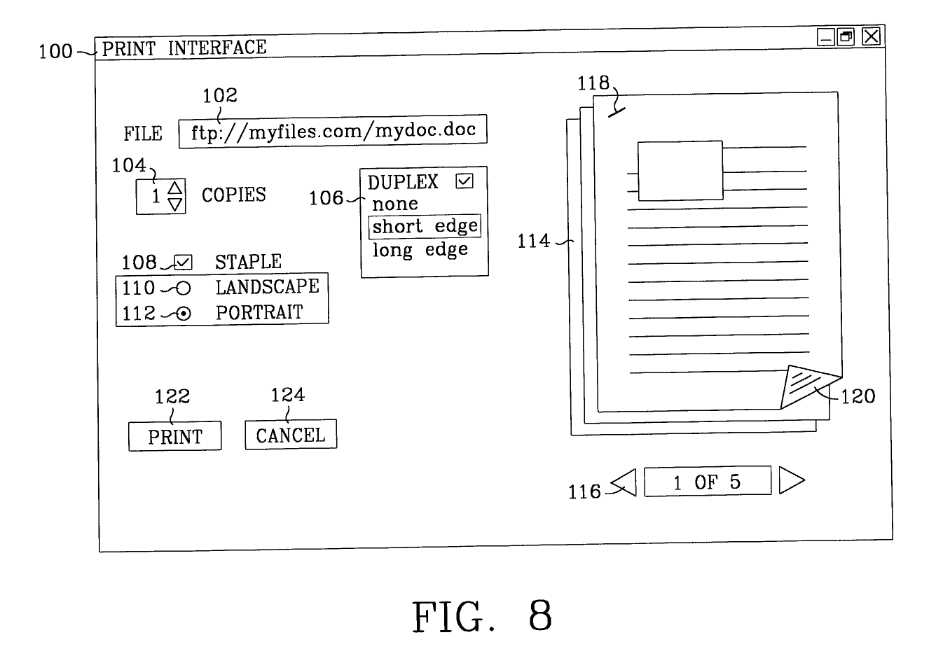

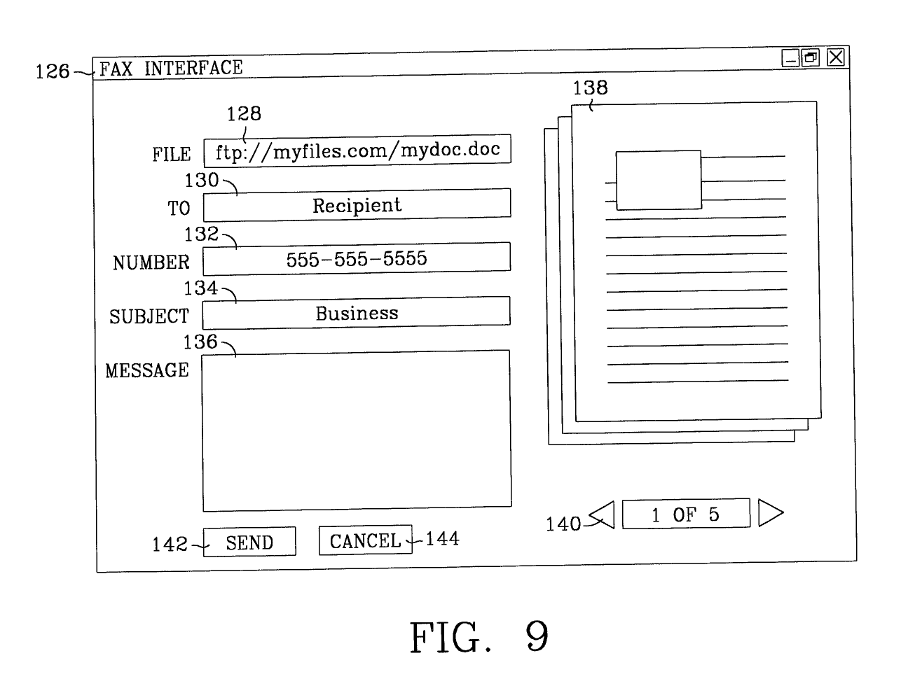

OPERATION: The operation of proxy service 22 will now be described with reference to the flow diagrams of FIGS. 6 and 7 and the exemplary screen views of FIGS. 8 and 9. As discussed earlier, proxy service 22 contains programming for dynamically updating its production logic enabling it to represent new devices connected to network 10. FIG. 6 provides an example of the steps taken to update proxy service 22. FIG. 7 provides an example of the steps taken by proxy service 22 when producing a target document. FIG. 8 illustrates a sample interface for a printer while FIG. 9 illustrates a sample interface for facsimile service.

Beginning with FIG. 6, upon detection of a new device (step 60), device locator 42 determines if the new device has self-representation capability (step 62). If it does, the process halts and device locator 42 continues to monitor network 10 looking for new devices. If it does not, update service 40 determines whether database 34 contains the logic for representing the newly connected device (step 64). This may be accomplished by searching database 34 for production logic for the particular device. If the required logic is not found, update service 40 obtains production logic for the new device from an external source (step 66). These sources may include the new device itself, removable media such as a floppy disk provided with the new device, or a web site maintained by the device's manufacturer or other device information service provider. If necessary, update service 40 provides production engine 38 with the driver for the new device (step 68).

Interface generator 32 creates an interface for the new device (step 70). Where interface generator 32 functions as a web server, the interface will be a web page with an assigned network address. The web page may be hosted in database 34, easily retrievable upon request from client 28.

Referring now to FIG. 7, when producing a document, a user first generates or otherwise identifies a target document (step 80). The target document may be contained on client device 12 or elsewhere. It need only be accessible by proxy service 22 over network 10. Next, the user issues a production request for the target document, accessing proxy service 22 (step 82). The term production request represents generally an action taken to initiate the production of a document. Where interface generator 32 functions as a web server and client 28 is a web browser, to issue a production request the user enters or otherwise accesses the network address of the web page for a particular production device. In response, proxy service 22 returns the web page for that device which is displayed by client 28 (step 84). It may well appear that the user is communicating directly with the selected production device 16 with the function of proxy service 22 remaining transparent.

The user selects the desired production options (step 86) and client 28 returns those selections to proxy service 22 (step 88). Along with those selections, client 28 may also return the target document or information on where proxy service 22 may locate and acquire the target document. Merging the target document with the selected options, production engine 38 generates a production plan (step 90) which is then delivered to the selected production device (step 92).

FIG. 8 illustrates a screen displaying a production user interface 100 for a printer as displayed in step 84. In this example, interface 100 includes control 102 for identifying the target document. Control 104 allows the user to select the number of copies to be printed. Controls 106 through 12 allow the user to select options such as duplexing, stapling, and landscape or portrait orientation. Control 114 provides a print preview for the document allowing the user to visualize the document before printing. Where the document contains multiple pages, control 116 allows a user to scroll through and preview each page. Print preview control 114 also reflects selected production options. Icon 118 shows that staple control 108 has been selected. Icon 120 shows that duplex control 106 has been selected. With the desired options selected, the user can then select print control 122 or may select cancel control 124.

FIG. 9 illustrates a screen displaying a production user interface 126 for a facsimile service. Here, the interface 126 includes control 128 for identifying the target document, control 130 for identifying the recipient, control 132 for providing a fax number, as well as controls 134 and 136 for supplying a subject line and message for a cover page. Control 138 provides a fax preview for the document allowing the user to visualize the document before sending. Where the document contains multiple pages, control 140 allows a user to scroll through and preview each page. With the desired options selected, the user can then select send control 142 or may select cancel control 144.

Although the flow charts of FIGS. 6 and 7 show a specific order of execution, the order of execution may differ from that which is depicted. For example, the order of execution of two or more blocks may be scrambled relative to the order shown. Also, two or more blocks shown in succession in FIGS. 6 and/or 7 may be executed concurrently or with partial concurrence. All such variations are within the scope of the present invention.

The screen displays of FIGS. 8 and 9 are exemplary only. There exist many possible layout and control configurations for an interface that will allow a user to select available production options. FIGS. 8 and 9 each merely provide one example.

The present invention has been shown and described with reference to the foregoing exemplary embodiments. It is to be understood, however, that other forms, details, and embodiments may be made without departing from the spirit and scope of the invention which is defined in the following claims.

What is claimed is:

1. A method for representing production devices on a network, the method comprising:
hosting an interface for one or more production devices, each interface having user accessible controls for selecting production options for a document;
providing the interface for a production device to a client upon request; and
managing the production of the document for the production device using production options selected through the interface.

2. The method of claim 1, further comprising detecting new production devices connected to the network, and hosting an interface for each new production device.

3. The method of claim 2, further comprising:
acquiring production logic for each detected production device;
using the production logic for each detected device, generating an interface having user accessible controls for selecting production options for and directing production of a document on that detected production device; and
associating the generated interface with a network address.

4. The method of claim 3, wherein the act of acquiring comprises identifying the new device and acquiring production logic for the identified device from a device information service.

5. The method of claim 1, wherein each interface is a web page associated with a network address, the act of hosting comprises hosting each interface on a web server, and the act of providing comprises providing the interface to a web browser.

6. The method of claim 1, wherein the interface is hosted and production of the document is managed on a device other than the production device.

7. A method for representing production devices on a network, the method comprising:
detecting new production devices connected to the network;
using the production logic for each detected device, generating an interface having user accessible controls for selecting production options for and directing production of a document on that detected production device;
hosting the generated interface for each production device;
providing the interface for a particular production device to a client upon request; and
managing the production of the document for the particular production device using production options selected through the interface.

8. A method for managing electronic document production over a computer network, the method comprising:
accessing a proxy service for a production device;
the proxy service, returning an interface having user accessible controls for selecting production options for a document;
returning selected production options to the proxy service; and
the proxy service managing production of the document for the production device using production options selected through the interface.

9. The method of claim 8, further comprising targeting a document and wherein the acts of returning an interface and managing production comprise returning the interface for selecting production options for the target document and managing production of the target document.

10. The method of claim 8, wherein the act of accessing includes accessing from a first network device and wherein the proxy service operates on a second network device different from the first network device.

11. The method of claim 8, wherein the proxy service includes a web server and the interface is a web page; the act of accessing includes browsing to a network address associated with the web page; and the act of returning includes returning the web page.

12. The method of claim 8, further comprising identifying the document before accessing the proxy service.

13. The method of claim 8, wherein the interface also includes a user accessible control or controls for identifying the document.

14. The method of claim 8, wherein the act of managing includes merging the document with the selected production options into a production plan and delivering the production plan in a device-understood format to the production device.

15. The method of claim 8, wherein the proxy service operates on a device other than the production device.

16. A computer program product for managing electronic document production over a computer network, the product comprising a computer useable medium having computer readable instructions thereon for:
receiving a production request for a production device;
returning to the client an interface for the production device, the interface having user accessible controls for selecting production options for a document;
managing the production of the document.

17. The product of claim 16, further comprising instructions for acquiring a target document and wherein the instructions for returning and managing comprise instructions for returning an interface for selecting production options for the target document and managing production of the target document.

18. The product of claim 16, further comprising instructions for detecting new production devices and generating an interface for each new production device detected.

19. The product of claim 16, further comprising instructions for identifying each new production device detected and acquiring production logic used to generate an interface for that production device.

20. The product of claim 19, wherein the instructions for acquiring the production logic comprise instructions for acquiring the production logic from a device information service.

21. The product of claim 16, wherein the instructions for receiving and managing comprise instructions for receiving and managing to be executed by a device other than the production device.

22. A system for representing production devices on a network, comprising:
a database containing production logic for one or more production devices;
an interface generator operable to access production logic for a production device in the database and serve an interface for the production device, the interface having user accessible controls for selecting production options for a document; and
a production engine, in electronic communication with the interface generator, the production engine operable to manage production of the document for the production device using the production options selected through the interface.

23. The system of claim 22, wherein the production engine includes:
a plan generator operable to merge the document with the production options selected through the interface; and
a device driver operable deliver the production plan to the production device.

24. The system of claim 22, further comprising a service engine operable to detect new production devices and to acquire production logic for each the detected production device.

25. The system of claim 24, wherein the service engine includes:
a device locator operable to detect and identify new devices present on the network; and
an update service operable to acquire the production logic for each of the detected devices and update the database with the acquired production logic.

26. The system of claim 22, wherein the interface generator is a web server and the interface is a web page.

27. The system of claim 22, wherein the interface generator and the production engine each operate on a device other than the production device.

28. A system for representing production devices on a network, comprising:
a database containing production logic for one or more production devices;
a device locator operable to detect and identify new devices present on the network;
an update service operable to acquire the production logic for each of the detected devices and update the database with the acquired production logic;
an interface generator operable to access the production logic for a production device in the database and serve an interface for the production device, the interface having user accessible controls for selecting production options for a document;
a plan generator operable to merge the document with production options selected through the interface; and
a device driver operable to deliver the production plan to the production device.

29. In a computer network, a system for managing electronic document production over a computer network, the system comprising:
one or more production devices;
a client operable to identify a document, select one of the one or more production devices, and direct a production request to the selected production device, and select production options;
a proxy service in electronic communication with the client and the production device, the proxy service operable to return to the client an interface for selecting production options and to manage the production of the document for the selected production device using production options selected through the interface.

30. The system of claim 29 wherein the proxy service includes a web server, the interface is a web page, and the client is a web browser.

31. The system of claim 29, wherein the proxy service includes:
a database containing production logic for at least one of the one or more production devices;
an interface generator operable to access the production logic in the database and serve the interface for the selected production device; and
a production engine operable to manage production of the document on the production device in accordance with the selected production options.

32. The system of claim 29, further comprising:
a device locator operable to detect and identify new production devices present on the network; and
an update service operable to acquire the production logic for each of the detected devices and update the database with the acquired production logic.

33. The system of claim 29 wherein the client operates on a first network device and the proxy service operates on a second network device different from the first network device.

34. The system of claim 29, wherein the proxy service operates on a device other than the selected production device.

35. In a computer network, a system for managing electronic document production over a computer network, the system comprising:
one or more production devices;
a database containing production logic for one or more production devices;
a device locator operable to detect and identify new devices present on the network;
an update service operable to acquire the production logic for each of the detected devices and update the database with the acquired production logic;
a client operable to identify a target document, select one of the one or more production devices, and direct a production request to the selected production device, and select production options;
an interface generator operable to access the production logic for the selected production device in the database and serve an interface for the selected production device, the interface having user accessible controls for selecting production options for the target document;
a plan generator operable to acquire the target document and merge it with production options selected through the interface forming a production plan; and
a device driver operable deliver the production plan to the production device.
